(19) United States
(12) Patent Application Publication
(10) Pub. No.: US 2026/0111836 A1
(43) Pub. Date: Apr. 23, 2026

(54) Electronic Devices and Corresponding Methods for Presenting Delivery Data Deviation Information

(71) Applicant: Motorola Mobility LLC, Chicago, IL (US)

(72) Inventors: Vijayprakash Idlur, Bangalore (IN); Nakul Patel, Nagpur (IN); Krishnan Raghavan, Bangalore (IN)

(21) Appl. No.: 18/924,784

(22) Filed: Oct. 23, 2024

(51) Int. Cl. G06Q 10/083; G06Q 30/0601

(52) U.S. Cl. CPC G06Q 10/0838; G06Q 30/0631

(57) ABSTRACT

An electronic device and method enhance the shopping experience by predicting delivery data deviations. The system operates within an electronic shopping environment, detecting user input for item selection and receiving proposed delivery data. The processors predict the accuracy of this data, identifying deviations beyond a threshold. When deviations occur, the system presents a prompt on the user interface, highlighting the discrepancy. The method can receive delivery data at user, item, and seller levels, and referencing historical delivery efficiency databases. The system can propose alternative items with lesser deviations, allowing users to make informed decisions. The device comprises a user interface, memory, and processors that determine predicted deviations and present prompts, enhancing reliability and satisfaction in e-commerce transactions.

### BACKGROUND

### Technical Field

This disclosure relates generally to electronic devices, and more particularly to electronic devices having user interfaces.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card. When used in conjunction with e-commerce sites, such devices make it incredibly simple to purchase goods and services with just a click or two.

At the same time, products ordered with a smartphone or other similar electronic device still must be physically delivered. Sometimes such deliveries are delayed, thereby leading to frustration. It would be advantageous to have improved electronic devices, methods, and corresponding systems that alleviate this problem.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one or more explanatory method steps in accordance with one or more embodiments of the disclosure.

FIG. 2 illustrates one explanatory electronic device in accordance with one or more embodiments of the disclosure.

FIG. 3 illustrates one explanatory method in accordance with one or more embodiments of the disclosure.

FIG. 4 illustrates one explanatory electronic device in accordance with one or more embodiments of the disclosure.

FIG. 5 illustrates one explanatory electronic device in accordance with one or more embodiments of the disclosure.

FIG. 6 illustrates one explanatory electronic device in accordance with one or more embodiments of the disclosure.

FIG. 7 illustrates one explanatory electronic device in accordance with one or more embodiments of the disclosure.

FIG. 8 illustrates one explanatory electronic device in accordance with one or more embodiments of the disclosure.

FIG. 9 illustrates one explanatory electronic device in accordance with one or more embodiments of the disclosure.

FIG. 10 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to in response to initiation of an interactive session in an electronic shopping interactive computing environment operating on one or more processors of the electronic device, detecting, by a user interface operable with the one or more processors, user input selecting an item associated with a fulfillment transaction, receiving, by the one or more processors, proposed delivery data associated with the fulfillment transaction, predicting, by the one or more processors, an accuracy of the proposed delivery data associated with the fulfillment transaction, and when the accuracy of the proposed delivery data represents a deviation beyond a threshold, presenting, by the one or more processors, a prompt highlighting the deviation in the proposed delivery data. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to one or more processors of an electronic device detecting user input selecting an item to be included in a fulfillment transaction within an interactive shopping session in an electronic shopping application operating on the one or more processors, determining a predicted deviation from a promised delivery time for the item and, when the predicted deviation exceeds a threshold, present a prompt on the user interface identifying the predicted deviation from the promised delivery time as described herein. The non-processor circuits may include, but are not limited to, a radio receiver, a radio transmitter, signal drivers, clock circuits, power source circuits, and user input devices.

As such, these functions may be interpreted as steps of a method to perform, in response to receipt of user input selecting an item to be associated with a fulfillment transaction within an interactive session in an electronic shopping interactive computing environment operating on one or more processors of the electronic device, extracting, by the one or more processors, delivery data at an item level, a user level, and a seller level. In one or more embodiments, the method further comprises predicting, by the one or more processors, an accuracy of the delivery data associated with the delivery data using prior extracted delivery data for the item at the seller level and user level and, when the accuracy of the delivery data deviates from a specified delivery time of the delivery data beyond a threshold, presenting, by the one or more processors, a prompt highlighting a predicted deviation from the specified delivery time.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Timely and reliable delivery remains an aspect of customer satisfaction in the e-commerce industry. Delays in delivery can lead to customer frustration, disrupt planned activities, and erode trust in the retailer's reliability.

This issue places a burden on customer service resources and may result in the loss of business as dissatisfied customers seek alternatives. Statistics indicate that a significant percentage of buyers will cease shopping with a retailer after experiencing late deliveries, highlighting the importance of addressing delivery efficiency to maintain a positive customer experience and sustain operational efficiency.

Existing systems often fail to provide accurate predictions of delivery times, leading to delays and customer dissatisfaction. These systems typically lack the ability to contextualize delivery data based on user profiles, seller performance, and item characteristics. As a result, customers may receive late deliveries without prior warning, impacting their purchasing decisions and overall satisfaction. The absence of a mechanism to predict and communicate potential delivery issues in advance further exacerbates the problem, leaving customers unable to manage their expectations effectively.

Illustrating by example, consider a user named Raj. Raj exhibits a pronounced inclination towards sweets, a characteristic often attributed to his sweet tooth. This predisposition drives a consistent craving for sugar, leading him to include various chocolates in his grocery orders. The physiological response to sugar, which can trigger the release of dopamine, enhances Raj's desire for these confections, making them a staple in his shopping list.

Raj's preference for specific types of chocolates stems from both taste and texture. He often selects milk chocolates for their creamy consistency and balanced sweetness, which provide a comforting and indulgent experience. Additionally, Raj favors dark chocolates with a higher cocoa content, appreciating their rich flavor profile and subtle bitterness. These choices reflect his desire for a diverse sensory experience, satisfying both his immediate craving for sweetness and his appreciation for complex flavors.

Incorporating chocolates such as truffles, pralines, and chocolate-covered nuts, Raj's selections demonstrate a penchant for variety. Truffles offer a smooth, melt-in-the-mouth sensation, while pralines provide a delightful crunch. Chocolate-covered nuts combine the sweetness of chocolate with the savory notes of nuts, creating a harmonious blend that Raj finds irresistible. These preferences highlight Raj's nuanced approach to satisfying his sweet tooth, ensuring each order caters to his diverse taste preferences.

Unfortunately, Raj frequently encounters a recurring issue with his chocolate orders, where certain items consistently fail to arrive. This pattern of missing chocolates persists despite multiple attempts to rectify the situation. Each time Raj places an order, he anticipates the delivery of his favorite treats, only to find some chocolates absent upon arrival. This consistent non-delivery necessitates Raj to request refunds repeatedly, adding to his frustration.

The anticipation of receiving his favorite chocolates heightens Raj's disappointment when the delivery falls short. The expectation of indulging in these treats turns into dissatisfaction as the missing items disrupt his plans. This ongoing issue not only affects Raj's shopping experience but also diminishes his trust in the reliability of the delivery service. The repeated need to seek refunds further compounds his dissatisfaction, leaving Raj disheartened with each incomplete delivery.

Raj, determined to solve the mystery of his missing chocolates, initiates contact with customer support. He meticulously documents each instance of non-delivery, providing detailed information about his orders, including the types of chocolates, order dates, and expected delivery times. Raj's persistence prompts the customer support team to conduct a thorough investigation into the delivery patterns associated with his address.

After a series of inquiries and investigations, the customer support team uncovers a pattern of inconsistent deliveries to Raj's area. The analysis reveals that certain chocolates consistently fail to reach specific addresses within the town. This inconsistency stems from logistical challenges faced by the delivery service, including routing inefficiencies and limited access to certain neighborhoods. The investigation highlights the need for improved delivery strategies to ensure reliable service to all areas.

Raj desperately desires a mechanism that could alert him in advance about potential delivery failures for certain items. Such a system would enable Raj to make informed decisions, allowing him to avoid ordering chocolates that are unlikely to be delivered successfully.

Indeed, the ability to predict delivery issues would empower Raj to select alternative products or sellers with a more reliable delivery track record. This proactive approach would not only enhance Raj's shopping experience but also reduce the frustration associated with missing items. By having access to delivery efficiency insights, Raj could ensure that his orders align with his expectations, thereby improving his overall satisfaction with the service.

Now consider another user named Rohan. Rohan meticulously planned a surprise for Aisha, one of his friends, by ordering a smartwatch to arrive precisely on her birthday. Despite Aisha's no-gift policy, Rohan wanted to make the occasion memorable. Accordingly, he coordinates the delivery to ensure the smartwatch would reach her doorstep just in time for the celebration.

Sadly, an email from the e-commerce platform disrupted his plans by notifying him of a delay in the delivery. The smartwatch would not arrive on time, leaving Rohan in a predicament.

Faced with this last-minute twist, Rohan contacts customer support, hoping for a resolution. The representative expresses sympathy and promises to expedite the delivery, but Rohan knew the efforts would not suffice to meet the deadline.

Determined to keep his promise, Rohan rushes to a local store the next morning to purchase the smartwatch in person. He plans to cancel the online order once he returned from the party.

Upon returning home, Rohan discovers that the smartwatch had been delivered to his family in his absence. Frustrated by the turn of events, he decided not to shop with the e-commerce site again. Rohan wishes for a system that could have alerted him in advance about potential delivery delays, allowing him to make informed decisions and avoid the inconvenience. Such a mechanism would have enabled Rohan to select alternative products or sellers with a more reliable delivery track record, enhancing his shopping experience and ensuring the timely arrival of his thoughtful gift.

Advantageously, embodiments of the disclosure provide a solution to the dilemmas plaguing both Raj and Rohan. In one or more embodiments, a method enhances the shopping experience by providing contextual delivery efficiency insights. In one or more embodiments, this method captures delivery data at various levels, including user, item, and seller, to predict delivery efficiency accurately. By contextualizing delivery status and efficiency based on user profiles, seller performance, and item characteristics, embodiments of the disclosure surface relevant information on the application to influence purchase decisions. In one or more embodiments, methods disclosed herein also propose alternatives when delivery is unlikely, offering suggestions for products with lower delivery deviations, thereby improving the overall user experience and reducing the likelihood of negative delivery experiences.

Advantageously, embodiments of the disclosure address the issue of regular missing products during delivery by capturing and analyzing delivery data at multiple levels, including user, item, and seller. Advantageously, this approach allows the system to identify patterns of non-delivery for specific items to certain addresses. By examining historical delivery data, the system can predict potential delivery failures and communicate these insights to users before they complete a purchase. This predictive capability enables users to make informed decisions, potentially avoiding items with a high likelihood of non-delivery.

In one or more embodiments, in response to the initiation of an interactive session within an electronic shopping interactive computing environment, a method involves detecting user input that selects an item associated with a fulfillment transaction. In one or more embodiments, the user interface, operable with one or more processors, facilitates this detection.

In one or more embodiments, upon receiving the proposed delivery data associated with the fulfillment transaction, the processors predict the accuracy of this data. In one or more embodiments, the prediction process involves analyzing the proposed delivery data to determine any potential deviations from the expected delivery timeline.

In one or more embodiments, when the predicted accuracy of the proposed delivery data indicates a deviation beyond a predefined threshold, the processors present a prompt on the user interface. In one or more embodiments, this prompt highlights the deviation in the proposed delivery data, thereby informing the user of potential discrepancies in the delivery schedule. Advantageously, the method ensures that users receive timely notifications about delivery deviations, allowing them to make informed decisions regarding their purchases.

Advantageously, embodiments of the disclosure enhance the shopping experience by allowing the electronic device to detect user input selecting an item associated with a fulfillment transaction and receive proposed delivery data. This setup enables the system to predict the accuracy of the delivery data, which is crucial for identifying potential deviations from the promised delivery schedule.

By presenting a prompt highlighting any deviation beyond a threshold, the method provides users with timely information about potential delivery issues. This proactive notification system allows users to make informed decisions, potentially avoiding dissatisfaction due to unexpected delivery delays.

The integration of this predictive capability into the user interface of the electronic device ensures that users are aware of delivery deviations before completing a purchase, thereby improving the overall reliability and satisfaction of the shopping experience.

In one or more embodiments, embodiments of the disclosure comprise a method to enhance the shopping experience by providing contextual delivery efficiency insights. The system captures delivery data at multiple levels, including user, item, and seller. This data includes the initial promised delivery date, actual delivery schedule, and order item status. The system contextualizes delivery status and efficiency based on user profiles, seller performance, and item characteristics. This information is surfaced on the application to influence purchase decisions.

When the deviation from the promised delivery date is high, the system highlights the delivery efficiency on the product page. This approach aims to prevent remorse purchases by informing users of potential delivery issues. Additionally, the system proposes alternative products with lower delivery deviations, subtly guiding users towards items with a more reliable delivery track record. This proactive method ensures users receive timely notifications about delivery deviations, allowing them to make informed decisions.

The system also includes a delivery efficiency predictor that updates a delivery efficiency database. This predictor analyzes historical delivery data to forecast delivery efficiency accurately. By presenting this information on the user interface, the system enhances the overall shopping experience, reducing the likelihood of negative delivery experiences and improving customer satisfaction.

Illustrating by example, an electronic device comprises a user interface, a memory, and one or more processors operable with the user interface and the memory. In one or more embodiments, the one or more processors, upon detecting user input selecting an item for inclusion in a fulfillment transaction within an interactive shopping session, determine a predicted deviation from a promised delivery time for the item. When the predicted deviation exceeds a threshold, the processors present a prompt on the user interface identifying the predicted deviation from the promised delivery time.

In one or more embodiments, the processors further propose, on the user interface within the electronic shopping interactive computing environment, alternative items having a lesser predicted deviation than that determined for the item to be included in the fulfillment transaction. This functionality allows users to make informed decisions by considering items with more reliable delivery schedules, thereby enhancing the overall shopping experience.

Advantageously, this arrangement allows the device to present a prompt on the user interface when the predicted deviation exceeds a threshold, thereby informing the user of potential delivery issues before completing a purchase. This setup enhances the user's ability to make informed decisions, potentially avoiding dissatisfaction due to unexpected delivery delays.

The integration of processors with the user interface and memory enables real-time analysis and presentation of delivery data, which is a novel approach compared to existing systems that may not provide such timely notifications. By predicting delivery deviations and alerting users, the device improves the reliability and satisfaction of the shopping experience, addressing common issues of late deliveries that can erode customer trust.

In one or more embodiments, in response to receiving user input selecting an item for inclusion in a fulfillment transaction within an interactive session in an electronic shopping interactive computing environment, a method involves extracting delivery data at multiple levels. In one or more embodiments, the one or more processors extract this data at an item level, a user level, and a seller level. This extraction process ensures that the system gathers comprehensive information necessary for accurate delivery predictions.

In one or more embodiments, the method further includes predicting the accuracy of the delivery data using prior extracted delivery data for the item at both the seller level and user level. This prediction process involves analyzing historical delivery data to determine potential deviations from a specified delivery time. By leveraging past delivery performance, the system can forecast delivery efficiency and identify any discrepancies that may arise.

When the accuracy of the delivery data deviates from the specified delivery time beyond a predefined threshold, in one or more embodiments the processors present a prompt on the user interface. This prompt highlights the predicted deviation from the specified delivery time, thereby informing the user of potential delivery issues. The method ensures that users receive timely notifications about delivery deviations, allowing them to make informed decisions regarding their purchases.

Advantageously, by extracting delivery data at multiple levels, including item, user, and seller, the method ensures comprehensive data collection necessary for accurate delivery predictions. In one or more embodiments, this multi-level data extraction allows the system to analyze historical delivery performance, providing a robust foundation for predicting delivery accuracy.

Predicting the accuracy of delivery data using prior extracted data enables the system to identify potential deviations from the specified delivery time. This predictive capability allows users to be informed of possible delivery issues before completing a purchase, enhancing their ability to make informed decisions.

Presenting a prompt that highlights predicted deviations from the specified delivery time ensures that users receive timely notifications about potential delivery discrepancies. This proactive approach helps users manage their expectations and avoid dissatisfaction due to unexpected delivery delays.

What is clear is that Raj and Rohan from the examples set forth above would both experience significant satisfaction with an electronic device configured in accordance with one or more embodiments of the disclosure. The device's ability to predict delivery deviations and provide timely notifications would address their previous frustrations with unreliable deliveries. By receiving alerts about potential delivery issues before completing a purchase, Raj could avoid ordering chocolates that consistently fail to arrive, while Rohan could ensure the timely arrival of gifts for occasions.

The device's integration of a delivery efficiency predictor would allow Raj and Rohan to make informed decisions by considering alternative products with more reliable delivery schedules. This proactive approach would enhance their shopping experience, reducing the likelihood of disappointment and improving overall satisfaction. The system's capability to contextualize delivery data based on user profiles, seller performance, and item characteristics would further empower them to select items with a higher probability of successful delivery.

By presenting prompts that highlight predicted deviations from promised delivery times, the device would provide Raj and Rohan with the necessary insights to manage their expectations effectively. This feature would not only improve their trust in the e-commerce platform but also streamline their purchasing process, ensuring a more predictable and satisfying experience. The electronic device's ability to enhance the shopping experience through contextual delivery efficiency insights would undoubtedly delight Raj and Rohan, offering them a reliable solution to their previous delivery challenges.

In the context of the example of Raj provided, embodiments of the disclosure would analyze the delivery history of chocolates to Raj's address. By identifying a consistent pattern of non-delivery, the system could alert Raj to the potential issue before he places an order. This alert would appear on the product page, allowing Raj to consider alternative products or sellers with a better delivery track record. The system's ability to provide such insights enhances the shopping experience by reducing the likelihood of disappointment and improving customer satisfaction.

Other advantages will be described below. Still others will be obvious to those of ordinary skill in the art having the benefit of this disclosure.

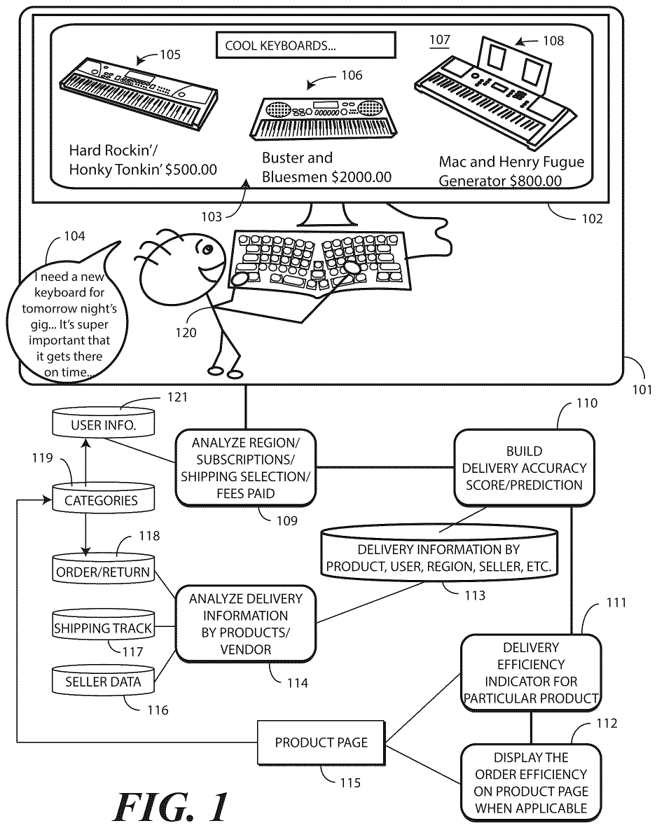

Turning now to FIG. 1, illustrated therein are one or more method steps in accordance with one or more embodiments of the disclosure. Beginning at step 101, Chuck 120 initiates an interactive session 103 in an electronic shopping interactive computing environment 107 on his electronic device 102. With a fancy gig scheduled for tomorrow night, Chuck 120 seeks a keyboard to elevate his performance, going so far as to exclaim 104, “I need a new keyboard for tomorrow night's gig . . . It's super important that it gets here on time.”

Indeed, Chuck 120 faces several potential issues if the ordered keyboard fails to arrive in time for the important gig. The absence of the keyboard may disrupt Chuck's performance, as the planned musical set relies on the specific features and sound quality of the chosen instrument. This disruption could lead to a compromised performance, affecting Chuck's reputation among peers and audience members.

Without the keyboard, Chuck 120 may need to resort to using an alternative instrument, which might not meet the required standards for the gig. This substitution could result in a less polished performance, potentially diminishing the overall impact of the event. Additionally, the lack of the expected equipment may cause stress and anxiety, impacting Chuck's focus and confidence during the performance.

The failure to deliver the keyboard on time could also lead to logistical challenges, such as last-minute attempts to procure a replacement. This situation may incur additional costs and time, further complicating Chuck's preparations for the gig. The cumulative effect of these issues could negatively influence Chuck's professional relationships and future opportunities within the music industry.

The options before him include the Hard Rockin', Honky Tonkin' keyboard 105, the Buster and his Bluesmen Officially Signed Signature Edition keyboard 106, and the Mac and Henry Fugue Generator keyboard 108. The Hard Rockin', Honky Tonkin' keyboard 105 offers a robust build and dynamic sound, ideal for energetic performances. The versatility of the Hard Rockin', Honky Tonkin' keyboard 105 makes the Hard Rockin', Honky Tonkin' keyboard 105 a reliable choice for various musical styles. The Mac and Henry Fugue Generator keyboard 108 provides advanced features for complex compositions, appealing to those who appreciate intricate musical arrangements.

Despite these options, Chuck 120 finds himself drawn to the Buster and his Bluesmen Officially Signed Signature Edition keyboard 106. Despite being priced at a whopping two thousand dollars, this keyboard stands out with the design and signature sound, capturing the essence of blues music. The craftsmanship associated with this edition resonate with Chuck's desire to make a memorable impression at his gig. The decision reflects Chuck's commitment to quality and his aspiration to deliver a performance.

Accordingly, Chuck 120 delivers user input to the electronic device 102 in the electronic shopping interactive computing environment 107 to order the Buster and his Bluesmen Officially Signed Signature Edition keyboard 106 to be delivered in a fulfillment transaction. At step 101, in response to the initiation of the interactive session 103 in the electronic shopping interactive computing environment 107 operating on one or more processors of the electronic device 102, a user interface operating with the one or more processors detects this user input selecting an item, which in this example is the Buster and his Bluesmen Officially Signed Signature Edition keyboard 106, to be associated with a fulfillment transaction.

Step 109 and step 114 then receive, by the one or more processors of the electronic device 102, proposed delivery data associated with the fulfillment transaction for the Buster and his Bluesmen Officially Signed Signature Edition keyboard 106. This data can take a variety of forms.

In one or more embodiments, the proposed delivery data received at step 109 is at a user level. In one or more embodiments, the proposed delivery data received at step 114 is received at an item level and a seller level.

Illustrating by example, in one or more embodiments the proposed delivery data at the user level comprises a user identifier and a delivery location, which can be received from a user information data store 121. Delivery location data within an electronic shopping interactive computing environment can encompass various elements, including user addresses, geolocation coordinates, and postal codes, also found in the user information data store 121.

User identifiers in an electronic shopping interactive computing environment 107 may include various forms of data that distinguish a user within the system. These identifiers can encompass user IDs, email addresses, phone numbers, and account numbers. The system may detect these identifiers through user input during account creation or login processes. For instance, when a user logs into the shopping platform, the system may prompt for an email address or phone number, which serves as a primary identifier. This information is then stored in the system's database, allowing for consistent recognition of the user in future interactions.

Detection of user identifiers may also occur through cookies or session tokens that track user activity across sessions. When a user accesses the platform, the system may retrieve a session token stored in the user's browser, linking the session to the user's account. This method enables seamless user experiences by maintaining continuity across different browsing sessions without requiring repeated logins. Additionally, the system may employ device fingerprinting techniques, which analyze device-specific information such as IP addresses, browser types, and operating systems to identify users. This approach enhances security by verifying the user's identity based on the device used to access the platform.

In some cases, biometric data such as fingerprints or facial recognition may serve as user identifiers. The system may detect these identifiers through integrated hardware on the user's device, such as fingerprint scanners or cameras. Upon successful verification, the system associates the biometric data with the user's account, providing a secure and convenient method for user identification. These various methods of detecting user identifiers ensure that the electronic shopping interactive computing environment can accurately recognize and authenticate users, thereby facilitating personalized shopping experiences and maintaining account security.

Delivery location data within an electronic shopping interactive computing environment can encompass various elements, including user addresses, geolocation coordinates, and postal codes. These data points are typically obtained through user input during the account creation or checkout process. Users may manually enter their delivery addresses, which the system stores in a database for future reference. This manual entry ensures that the delivery location is accurate and tailored to the user's specific needs.

Geolocation coordinates can be obtained through the device's GPS functionality, provided the user grants permission. This method allows the system to automatically detect the user's current location, offering a convenient option for users who prefer not to manually input their address. The system can then use these coordinates to determine the most efficient delivery route, enhancing the overall delivery process.

Postal codes serve as another component of delivery location data. Users typically provide postal codes as part of their address information, enabling the system to categorize delivery locations based on regional distribution. This categorization assists in optimizing delivery logistics by grouping orders within the same postal code area, thereby improving delivery efficiency and reducing transit times.

In one or more embodiments, the proposed delivery data at the user level received at step 109 from the user information data store 121 further comprises a subscription plan defining shipping terms within the electronic shopping interactive computing environment. The shipping selection and the amount of fees paid for shipping can be considered at step 109 as well.

Illustrating by example, determining a subscription plan defining shipping terms within the electronic shopping interactive computing environment 107 at step 109 can play a role in understanding the shipping selection made by Chuck 120. The subscription plan may outline specific shipping options available to the user, including delivery speed, cost, and any associated benefits such as free shipping or priority handling. By analyzing the subscription plan, the system can tailor the delivery options presented to Chuck 120, ensuring alignment with his preferences and expectations. This alignment enhances the user experience by providing relevant shipping choices that meet Chuck's needs, thereby facilitating a more efficient and satisfactory transaction process.

The shipping selection made by Chuck 120 can directly influences the delivery timeline and associated costs. By considering the subscription plan, the system can offer Chuck 120 a range of shipping options that align with his plan's terms, such as expedited delivery or standard shipping. This consideration ensures that Chuck 120 receives accurate information about the expected delivery time and any additional fees that may apply. By presenting these options clearly, the system empowers Chuck 120 to make informed decisions regarding his purchase, balancing cost and delivery speed according to his priorities.

The fees paid by Chuck 120 for shipping are a factor in the overall transaction cost. By integrating the subscription plan's terms, the system can accurately calculate and present the shipping fees associated with each option. This transparency allows Chuck 120 to evaluate the total cost of his purchase, including shipping, and make decisions that align with his budget. By providing a clear breakdown of shipping fees, the system enhances trust and satisfaction, ensuring that Chuck 120 is fully aware of the financial implications of his shipping selection.

The proposed delivery data at the seller level analyzed at step 114 can comprise a seller identity contained in a seller data store 116 and a shipment location from a shipping and tracking data store 117. In one or more embodiments, the proposed delivery data analyzed at step 114 can further comprise a shipment service delivering the item from the shipment location to the delivery location contained in the shipping and tracking data store 117.

Considering the shipment location, shipment service, and seller identity at step 114 of FIG. 1 can be important for accurately predicting delivery efficiency. The shipment location provides insight into the geographical origin of the item, which can influence transit times and potential delays. By analyzing the shipment location at step 114, the system can assess regional factors such as weather conditions, transportation infrastructure, and local regulations that may impact delivery schedules.

The shipment service considered at step 114 also plays a role in determining the reliability and speed of the delivery process. Different shipment services have varying levels of efficiency, coverage, and service quality. By evaluating the shipment service at step 114, the system can incorporate known performance metrics, such as average delivery times and success rates, into the prediction model. This information allows for a more precise estimation of the expected delivery timeline.

The seller identity is another factor that can be considered at step 114, as the seller identity provides context regarding the seller's historical performance and reliability. Sellers with a track record of timely deliveries and accurate order fulfillment contribute positively to the delivery prediction. Sellers with frequent delays or issues may indicate a higher risk of delivery deviations. By considering the seller identity, the system can adjust predictions based on the seller's past behavior, enhancing the accuracy of the delivery efficiency assessment.

At the item level, an item identifier can be considered by both step 109 and step 114. This can be an identifier of a single item or a category of items and can be stored in a category or item data store 119.

Once this data is gathered, it can be compiled into a combined data store 113. In one or more embodiments, step 110 then comprises contextualizing a delivery status and efficiency by user profile, optionally considering the user's location and/or zip code, the seller, the item, and other information.

In one or more embodiments, step 110 comprises predicting, by one or more processors of the electronic device 102, an accuracy of the proposed delivery data associated with the fulfillment transaction. In one or more embodiments, step 110 comprises referencing, by the one or more processors, a past delivery efficiency database storing historical delivery data for the item at the seller level and the user level.

When the accuracy of the proposed delivery data represents a deviation beyond a threshold, in one or more embodiments step 111 comprises presenting, by the one or more processors, a prompt highlighting the deviation in the proposed delivery data. While this can be done in response to the user input selecting the item to be associated with the fulfillment transaction, in other embodiments step 112 can comprise presenting the prompt highlighting the deviation on the product page 115 as well. In one or more embodiments, step 111 further proposes, by the one or more processors within the electronic shopping interactive computing environment 107, alternative items having a lesser deviation in the accuracy of the proposed delivery data as well.

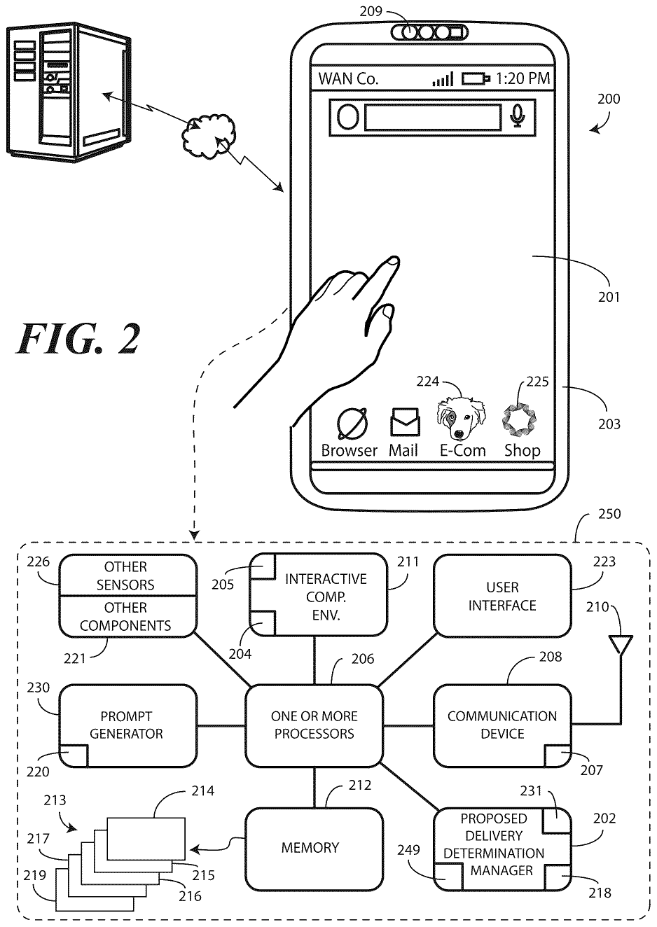

Turning now to FIG. 2, illustrated therein is one explanatory electronic device 200 configured in accordance with one or more embodiments of the disclosure. The electronic device 200 of this illustrative embodiment includes a user interface 223. In one or more embodiments, the user interface 223 comprises a display 201, which may optionally be touch-sensitive. The display 201 can serve as a primary user interface 223 of the electronic device 200.

Where the display 201 is touch sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 200 of FIG. 2 includes a housing 203. Features can be incorporated into the housing 203. Examples of features that can be included along the housing 203 include an imager 209, shown as a camera in FIG. 2, or an optional speaker port. A user interface component, which may be a button or touch sensitive surface, can also be disposed along the housing 203.

A block diagram schematic 250 of the electronic device 200 is also shown in FIG. 2. In one embodiment, the electronic device 200 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device.

The application processor and the auxiliary processor(s) can be operable with the various components of the electronic device 200. Each of the application processor and the auxiliary processor(s) can be configured to process and execute executable software code to perform the various functions of the electronic device 200. A storage device, such as memory 212, can optionally store the executable software code used by the one or more processors 206 during operation.

In this illustrative embodiment, the electronic device 200 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas 210.

The electronic device 200 can optionally include a near field communication circuit 207 used to exchange data, power, and electrical signals between the electronic device 200 and another electronic device. In one embodiment, the near field communication circuit 207 is operable with a wireless near field communication transceiver, which is a form of radio-frequency device configured to send and receive radio-frequency data to and from the companion electronic device or other near field communication objects.

Where included, the near field communication circuit 207 can have its own near field communication circuit controller in one or more embodiments to wirelessly communicate with companion electronic devices using various near field communication technologies and protocols. The near field communication circuit 207 can include-as an antenna-a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 200. For example, in one embodiment the one or more processors 206 comprise one or more circuits operable to present presentation information, such as images, text, and video, on the display 201.

When an electronic shopping application 225 is actuated, the one or more processors 206 can present an electronic shopping interactive computing environment 211 to a user on the display 201, within which the user can enter an interactive session 204 and make user interaction events. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 200.

The application service layer 215 can be responsible for executing application service modules. The application service modules may support one or more applications 217 or “apps.” Examples of such applications include a cellular telephone application for making voice telephone calls, a web browsing application configured to allow the user to view webpages on the display 201 of the electronic device 200, an electronic mail application configured to send and receive electronic mail, a photo application configured to organize, manage, and present photographs on the display 201 of the electronic device 200, and a camera application for capturing images with the imager 209.

Collectively, these applications constitute an “application suite.” In one or more embodiments, these applications comprise one or more e-commerce applications 224 and/or electronic shopping applications 225 that allow electronic commerce orders to be placed and financial transactions to be made using the electronic device 200.

Illustrating by example, in one or more embodiments a user can deliver user input to an e-commerce application 224 to launch an interactive session 204 of an electronic shopping interactive computing environment 211 that operates on the one or more processors 206. They can then deliver user input to the user interface 223 to define one or more search strings corresponding to one or more categories within the electronic shopping interactive computing environment 211. The one or more processors 206 can then monitor user interaction events in the electronic shopping interactive computing environment 211 to detect user input selecting an item associated with a fulfillment transaction as previously described.

In one or more embodiments, in response to the one or more processors 206 detecting user input selecting an item to be included with a fulfillment transaction 205 within an electronic shopping application 225 operating on the one or more processors 206, using a proposed delivery determination manager 202, determine a predicted deviation 231 from a promised delivery time 218 for the item. In one or more embodiments, when the predicted deviation 231 exceeds a threshold, a prompt generator 230 presents a prompt 220 on the user interface 223 identifying the predicted deviation 231 from the promised delivery time 218.

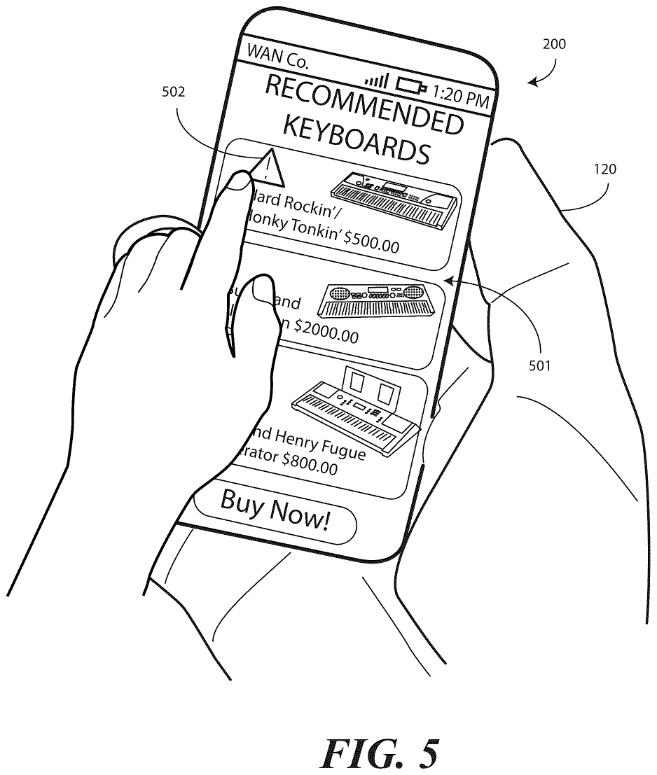

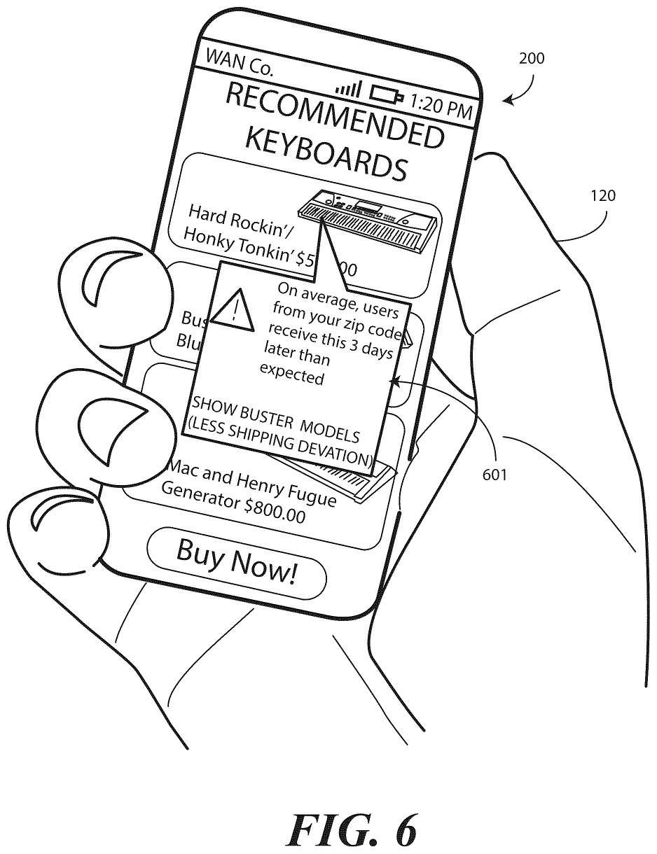

In one or more embodiments, as will be described in more detail below with reference to FIGS. 5-6, the prompt 220 comprises a user actuation target configured as a symbol. In one or more embodiments, the predicted deviation 231 from the promised delivery time is initially hidden when the prompt 220 is presented but revealed in response to other user input actuating the user actuation target.

In one or more embodiments, the proposed delivery determination manager 202 further proposes, on the user interface 223 within the electronic shopping interactive computing environment 211, alternative items 249 having a lesser predicted deviation than that determined for the item to be included in the fulfillment transaction 205. In one or more embodiments, the proposed delivery determination manager 202 further identifies, on the user interface 223 within the electronic shopping interactive computing environment 211, the lesser predicted deviation when proposing the alternative items 249.

For the proposed delivery determination manager 202 to determine the predicted deviation 231, the proposed delivery determination manager 202 further extracts, from the fulfillment transaction 205, an item identifier, a seller identifier, a shipment location, a delivery location, and a shipment service. In one or more embodiments, the predicted deviation 231 is determined as a function of the item identifier, the seller identifier, the shipment location, the delivery location, and the shipment service. In one or more embodiments, the proposed delivery determination manager 202 is further configured to update a delivery efficiency database 219 with the predicted deviation 231.

In one or more embodiments the one or more processors 206 are responsible for managing the applications and all personal information received from the user interface 223 that is to be used by the e-commerce application 224 and/or electronic shopping application 225 after the electronic device 200 is authenticated as a secure electronic device and the user identification credentials have triggered an electronic payment transaction request to complete an electronic shopping cart interaction event. The one or more processors 206 can also be responsible for launching, monitoring, and killing the various applications and the various application service modules.

In one or more embodiments, the one or more processors 206 are operable to not only kill the applications, but also to expunge any and all personal data, data, files, settings, or other configuration tools when the electronic device 200 is reported stolen or when the e-commerce application 224 and/or electronic shopping application 225 are used with fraudulent activity to wipe the memory 212 clean of any personal data, preferences, or settings of the person previously using the electronic device 200.

The one or more processors 206 can also be operable with other components 221. The other components 221, in one embodiment, include input components, which can include acoustic detectors as one or more microphones. The one or more processors 206 may process information from the other components 221 alone or in combination with other data, such as the information stored in the memory 212 or information received from the user interface.

The other components 221 can include a video input component such as an optical sensor, another audio input component such as a second microphone, and a mechanical input component such as button. The other components 221 can include one or more sensors 226, which may include key selection sensors, touch pad sensors, capacitive sensors, motion sensors, and switches. Similarly, the other components 221 can include video, audio, and/or mechanical outputs.

The one or more sensors 226 may include, but are not limited to, accelerometers, touch sensors, surface/housing capacitive sensors, audio sensors, and video sensors. Touch sensors may be used to indicate whether the electronic device 200 is being touched at side edges. The other components 221 of the electronic device can also include a device interface to provide a direct connection to auxiliary components or accessories for additional or enhanced functionality and a power source, such as a portable battery, for providing power to the other internal components and allow portability of the electronic device 200.

In one or more embodiments, the proposed delivery determination manager 202 and the prompt generator 230 can be operable with one or more processors 206, configured as a component of the one or more processors 206, or configured as one or more executable code modules operating on the one or more processors 206. In other embodiments, the proposed delivery determination manager 202 and the prompt generator 230 can be standalone hardware components operating executable code or firmware to perform their functions. Other configurations for the proposed delivery determination manager 202 and the prompt generator 230 will be obvious to those of ordinary skill in the art having the benefit of this disclosure.

It is to be understood that FIG. 2 is provided for illustrative purposes only and for illustrating components of one electronic device 200 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

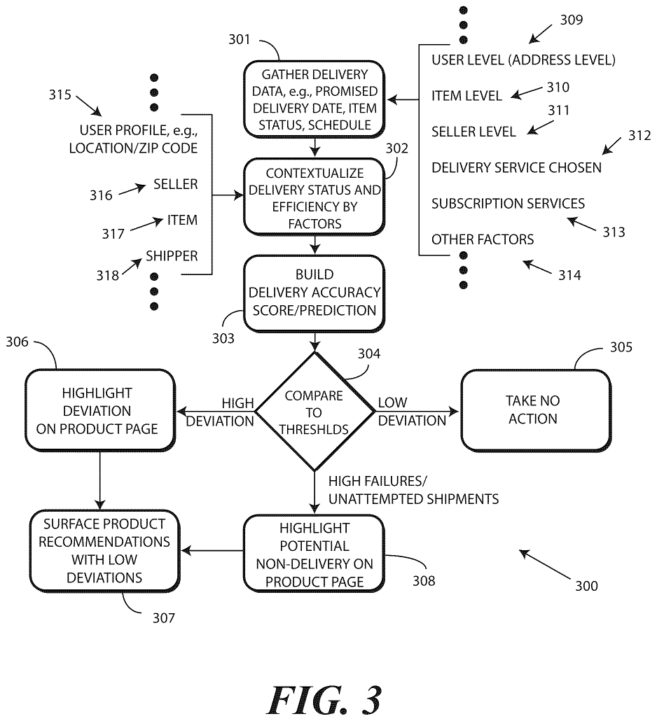

Turning now to FIG. 3, illustrated therein is one explanatory method 300 in accordance with one or more embodiments of the disclosure. Step 301 of the method 300 of FIG. 3 involves, in response to receipt of user input selecting an item to be associated with a fulfillment transaction within an interactive session in an electronic shopping interactive computing environment operating on one or more processors of an electronic device, the one or more processors extracting delivery data. In one or more embodiments, this extraction occurring at step 301 occurs at a user level 309, and item level 310, and a seller level 311. Other factors 314, including the delivery service 312 selected for the item and whether the purchaser has any subscription service contracts 313 utilizing a particular mode of delivery can be considered as well.

In one or more embodiments, step 301 captures information such as the initial promised delivery date, the actual delivery schedule, and an order item status for all orders for the user. This too can occur at a user level 309, an item level 310, and a seller level 311.

At step 302, the method 300 contextualizes the delivery status and efficiency as a function of a user profile 315, which may include location, zip code, and other information, the seller 316, the item 317, and the shipper 318. In one or more embodiments, step 303 then comprises predicting an accuracy of the delivery data associated with the delivery data using prior extracted delivery data for the item 317 at the seller level 311 and the user level 309.

Decision 304 then determines whether the accuracy of the delivery data deviates from a specified delivery time of the delivery data beyond a threshold. Where there is low or no deviation from the promised delivery date, step 305 takes no action. However, when the accuracy of the delivery data deviates from a specified delivery time of the delivery data beyond a threshold, step 306 and step 308 can comprise presenting a prompt highlighting a predicted deviation from the specified delivery time.

Illustrating by example, in one or more embodiments where there is a high deviation from promised delivery date, step 306 can subtly highlight the delivery efficiency against the promised delivery schedule on product page to avoid remorse purchase. Where there is a number of high delivery failures or un-attempted shipments, step 308 can highlight the possible non-delivery of the item to avoid a remorse purchase.

Additionally, in one or more embodiments the method 300 can propose alternatives as well. Illustrating by example, step 307 can, in case of high deviation from promised delivery or high undelivered items, surface product recommendations for items with low delivery date deviations. In one or more embodiments, step 307 therefore subtly nudges the user towards a product that has less chances of resulting in poor delivery experience.

In one or more embodiments, the prompt presented at step 306 and/or step 308 can comprise a user actuation target that, when actuated, causes the user interface to propose the alternative items at step 307 that deviate less from the specified delivery time than the predicted deviation. In one or more embodiments, the alternative items proposed at step 307 are prioritized from lowest deviation from the specified delivery time to the highest deviation from the specified delivery time. Either step 306 or step 308 can comprise updating a delivery efficiency database with the predicted deviation from the specified delivery time.

Now that electronic devices and corresponding methods in accordance with embodiments of the disclosure have been described, attention will be turned to some particular and illustrative use cases to better understand embodiments of the disclosure and the corresponding prompts.

Recall from above that our musician friend from FIG. 1, Chuck 120, initiated an interactive session within an electronic shopping interactive computing environment on his electronic device. Chuck 120 sought to purchase a keyboard for an upcoming performance, emphasizing the importance of timely delivery. The options available to Chuck 120 include the Hard Rockin', Honky Tonkin' keyboard, the Buster and his Bluesmen Officially Signed Signature Edition keyboard, and the Mac and Henry Fugue Generator keyboard. Each keyboard offers distinct features, catering to different musical styles and preferences.

Chuck 120 selected the Buster and his Bluesmen Officially Signed Signature Edition keyboard, drawn by the design and signature sound. This choice reflected Chuck's commitment to quality and his aspiration to deliver a memorable performance. Upon selecting the keyboard, the electronic device processes the proposed delivery data, considering factors such as user level, item level, and seller level. The system predicts the accuracy of the delivery data, assessing potential deviations from the promised delivery time.

When the predicted deviation exceeds a threshold, the system presents a prompt on the user interface, highlighting the potential delivery issue. Such is the case in FIG. 5. Poor Chuck 120!

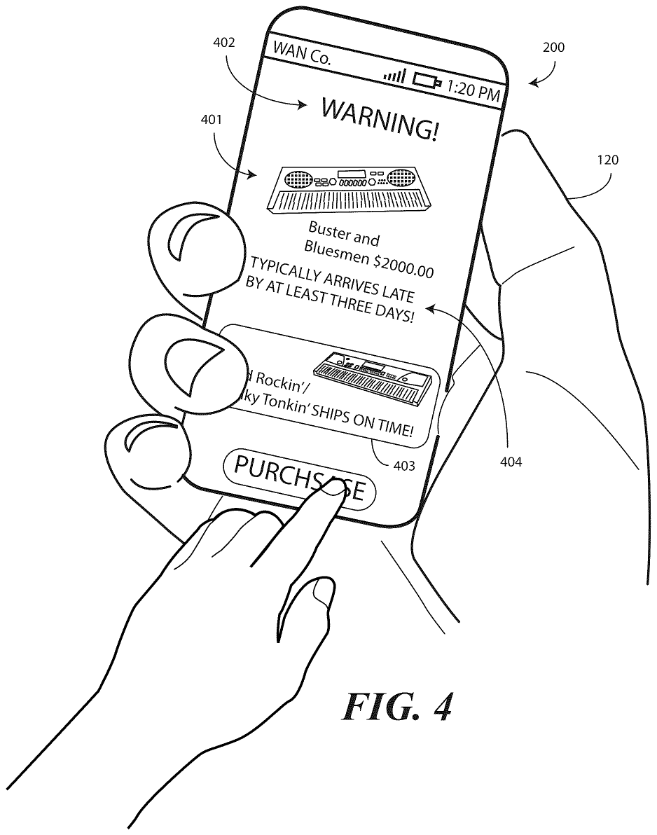

As it turns out, the accuracy of the proposed delivery data represents a deviation from the date promised by the seller's information in the electronic shopping interactive computing environment by at least three days. Accordingly, as shown in FIG. 4 the one or more processors of the electronic device 200 have presented a prompt 401 highlighting the deviation 404 in the proposed delivery data. This prompt 401 includes a large warning 402, which allows Chuck 120 to make an informed decision, considering alternative products with more reliable delivery schedules if necessary.

Indeed, in FIG. 4 the prompt 401 includes a proposal 403 of alternative items having a lesser deviation in the accuracy of the proposed delivery data. In this example, the prompt 401 notes that the Hard Rockin' Honkey Tonkin' keyboard will ship and arrive on time. Using this information, Chuck 120 can manage his expectations and avoid disruptions to his performance plans, enhancing his overall shopping experience.

Turning now to FIG. 5, in this illustration a prompt warning about the Hard Rockin' Honkey Tonkin' keyboard having an accuracy of delivery data that deviates from a specified delivery time of the delivery data advertised by the electronic shopping interactive computing environment. In this illustrative embodiment, the prompt 501 includes a user actuation target 502 that is configured as a symbol. The symbol in this illustrative example is a triangle with an exclamation point situated within the perimeter of the triangle. Other symbols will be obvious to those of ordinary skill in the art having the benefit of this disclosure.

In FIG. 5, the predicted deviation from the promised delivery time is initially hidden when the prompt 501 is presented. However, Chuck 12 is delivering user input to the user actuation target 502. As shown in FIG. 6, in one or more embodiments, this user input causes the predicted deviation 601 to be revealed to Chuck 120.

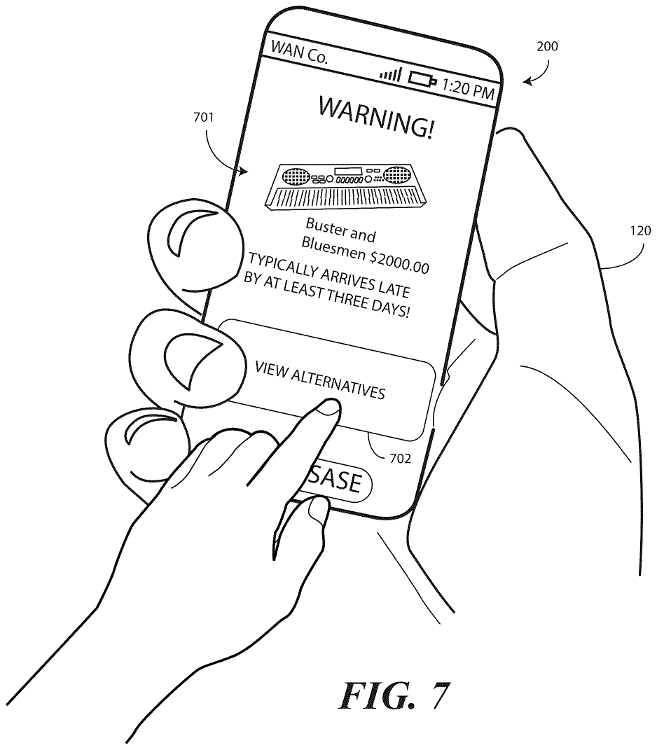

Turning now to FIG. 7, another prompt 701 is presented on the electronic device 200 when the predicted deviation exceeds a threshold. In this illustration, the prompt 701 comprises a user actuation target 702 that, when actuated, causes a user interface of the electronic device 200 to propose alternative items deviating less from the specified delivery time than the predicted deviation. Chuck 120, desiring to see these alternatives, delivers user input to the user actuation target 702 in FIG. 7.

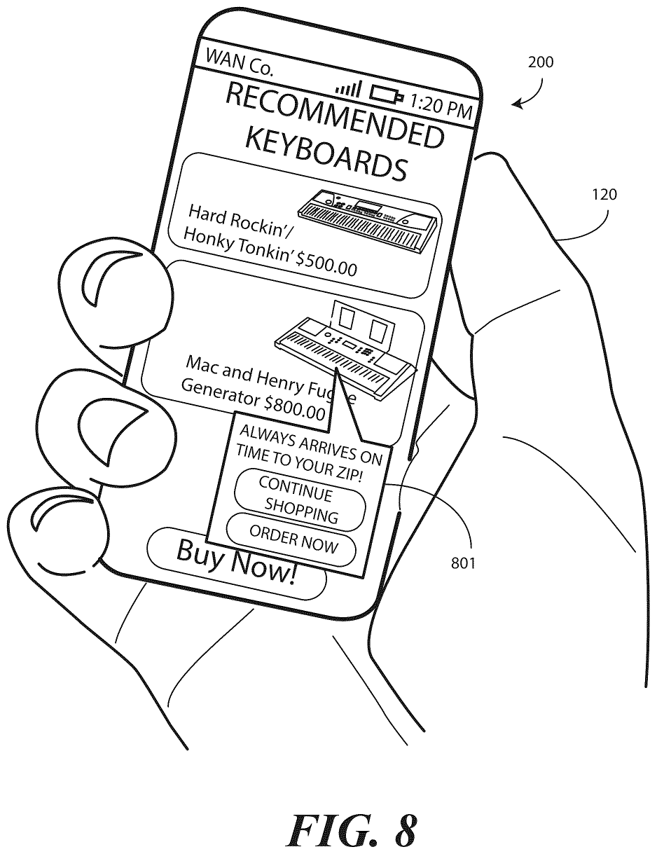

As shown in FIG. 8, in one or more embodiments this causes the user interface of the electronic device 200 to propose alternative items deviating less from the specified delivery time than the predicted deviation. In one or more embodiments, the alternative items are prioritized from lowest deviation from the specified delivery time to the highest deviation from the specified delivery time. In FIG. 8, a buy now user actuation target 801 identifies the alternative item having the lowest deviation from the specified delivery time, which allows Chuck 120 to make an instant purchase that assures his ability to perform at the gig tomorrow night.

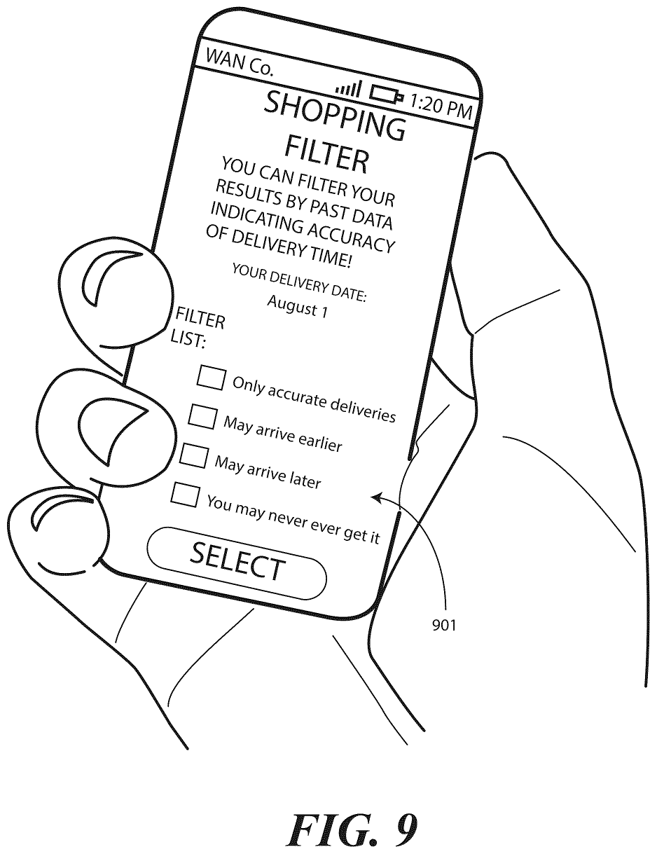

Turning now to FIG. 9, in one or more embodiments the user interface can further present filter options 901 to exclude other items having a predicted deviation from the specified delivery times. This allows a use to select, for example, only accurate deliveries and those that may arrive earlier than expected. This advantageously allows the user to weed out those deliveries that may arrive late or may never arrive.

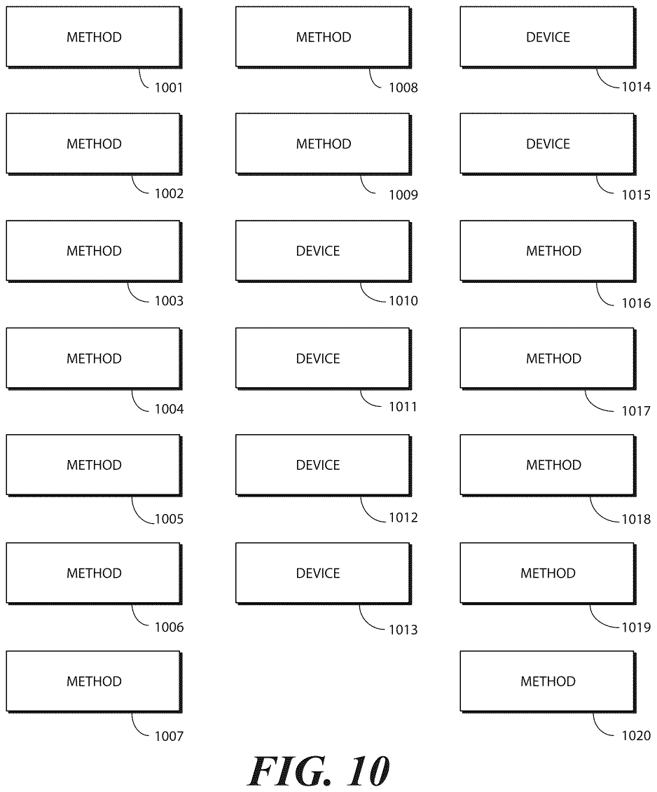

Turning now to FIG. 10, illustrated therein are various embodiments of the disclosure. The embodiments of FIG. 10 are shown as labeled boxes in FIG. 10 due to the fact that the individual components of these embodiments have been illustrated in detail in FIGS. 1-9, which precede FIG. 10. Accordingly, since these items have previously been illustrated and described, their repeated illustration is no longer essential for a proper understanding of these embodiments. Thus, the embodiments are shown as labeled boxes.

At 1001, a method in an electronic device comprises, in response to initiation of an interactive session in an electronic shopping interactive computing environment operating on one or more processors of the electronic device, detecting, by a user interface operable with the one or more processors, user input selecting an item associated with a fulfillment transaction. In one or more embodiments, the method comprises receiving, by the one or more processors, proposed delivery data associated with the fulfillment transaction.

In one or more embodiments, the method comprises predicting, by the one or more processors, an accuracy of the proposed delivery data associated with the fulfillment transaction. In one or more embodiments, when the accuracy of the proposed delivery data represents a deviation beyond a threshold, the method comprises presenting, by the one or more processors, a prompt highlighting the deviation in the proposed delivery data.

At 1002, the method of 1001 comprises receiving the proposed delivery data at a user level, an item level, and a seller level. At 1003, the proposed delivery data of 1002 at the user level comprises a user identifier and a delivery location. At 1004, the proposed delivery data of 1003 at the user level further comprises a subscription plan defining shipping terms within the electronic shopping interactive computing environment.

At 1005, the proposed delivery data at the seller level of 1004 comprises a seller identity and a shipment location. At 1006, the proposed delivery data at the seller level of 1005 further comprises a shipment service delivering the item from the shipment location to the delivery location. At 1007, the proposed delivery data at the item level of 1006 comprises an item identifier.

At 1008, the predicting of 1001 comprises referencing, by the one or more processors, a past delivery efficiency database storing historical delivery data for the item at the seller level and the user level. At 1009, the method of 1001 further comprises proposing, by the one or more processors within the electronic shopping interactive computing environment, alternative items having a lesser deviation in the accuracy of the proposed delivery data.

At 1010, an electronic device comprises a user interface, a memory, and one or more processors operable with the user interface and the memory. At 1010, the one or more processors, in response to the one or more processors detecting user input selecting an item to be included in a fulfillment transaction within an interactive shopping session in an electronic shopping application operating on the one or more processors, determine a predicted deviation from a promised delivery time for the item. At 1010, when the predicted deviation exceeds a threshold, present a prompt on the user interface identifying the predicted deviation from the promised delivery time.

At 1011, the one or more processors of 1010 further propose, on the user interface within the electronic shopping interactive computing environment, alternative items having a lesser predicted deviation than that determined for the item to be included in the fulfillment transaction. At 1012, the one or more processors of 1011 further identify, on the user interface within the electronic shopping interactive computing environment, the lesser predicted deviation when proposing the alternative items.

At 1013, the one or more processors of 1011 further extract, from the fulfillment transaction, an item identifier, a seller identifier, a shipment location, a delivery location, and a shipment service. At 1013, the predicted deviation is determined as a function of the item identifier, the seller identifier, the shipment location, the delivery location, and the shipment service.

At 1014, the one or more processors of 1010 are further configured to update a delivery efficiency database with the predicted deviation. At 1015, the prompt of 1010 comprises a user actuation target configured as a symbol, wherein the predicted deviation from the promised delivery time is initially hidden when the prompt is presented but revealed in response to other user input actuating the user actuation target.

At 1016, a method in an electronic device comprises, in response to receipt of user input selecting an item to be associated with a fulfillment transaction within an interactive session in an electronic shopping interactive computing environment operating on one or more processors of the electronic device, extracting, by the one or more processors, delivery data at an item level, a user level, and a seller level. At 1016, the method comprises predicting, by the one or more processors, an accuracy of the delivery data associated with the delivery data using prior extracted delivery data for the item at the seller level and user level. At 1016, when the accuracy of the delivery data deviates from a specified delivery time of the delivery data beyond a threshold, the method comprises presenting, by the one or more processors, a prompt highlighting a predicted deviation from the specified delivery time.

At 1017, the prompt of 1016 includes a user actuation target that, when actuated, causes a user interface to propose alternative items deviating less from the specified delivery time than the predicted deviation. At 1018, the method of 1017 further comprises prioritizing the alternative items from lowest deviation from the specified delivery time to highest deviation from the specified delivery time.

At 1019, the method of 1016 further comprises updating, by the one or more processors, a delivery efficiency database with the predicted deviation from the specified delivery time. At 1020, the method of 1016 further comprises presenting, by the one or more processors on a user interface within the electronic shopping interactive computing environment, filter options to exclude other items having a predicted deviation from the specified delivery time.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, other embodiments can comprise a method that enhances the shopping experience by providing contextual delivery efficiency insights. The system captures delivery data at various levels, including user, item, and seller. This data includes the initial promised delivery date, actual delivery schedule, and order item status. The system contextualizes delivery status and efficiency based on user profiles, seller performance, and item characteristics. This information is surfaced on the application to influence purchase decisions.

When the deviation from the promised delivery date is high, the system highlights the delivery efficiency on the product page. This approach aims to prevent remorse purchases by informing users of potential delivery issues. Additionally, the system proposes alternative products with lower delivery deviations, subtly guiding users towards items with a more reliable delivery track record. This proactive method ensures users receive timely notifications about delivery deviations, allowing them to make informed decisions.

The system also includes a delivery efficiency predictor that updates a delivery efficiency database. This predictor analyzes historical delivery data to forecast delivery efficiency accurately. By presenting this information on the user interface, the system enhances the overall shopping experience, reducing the likelihood of negative delivery experiences and improving customer satisfaction.

In still other embodiments, the system for presenting delivery data deviation information can be implemented with different configurations and operational methods. One embodiment involves a user interface that dynamically adjusts based on user preferences, allowing for customizable alerts regarding delivery deviations.

The system may utilize a range of data sources, such as real-time tracking information and historical delivery data, to enhance prediction accuracy. In another embodiment, the system could integrate with third-party logistics providers to access broader datasets, improving the reliability of delivery predictions.

The user interface might include interactive elements, such as touch-sensitive displays or voice-activated commands, to facilitate user interaction and decision-making. Additionally, the system could be configured to operate on various electronic devices, from smartphones to tablets, ensuring adaptability across different platforms.

The delivery efficiency predictor might employ machine learning algorithms to continuously refine predictions based on evolving data patterns, offering users increasingly accurate insights over time. These embodiments demonstrate the system's flexibility and potential to enhance the shopping experience by providing timely and relevant delivery information.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
in response to initiation of an interactive session in an electronic shopping interactive computing environment operating on one or more processors of the electronic device, detecting, by a user interface operable with the one or more processors, user input selecting an item associated with a fulfillment transaction;
receiving, by the one or more processors, proposed delivery data associated with the fulfillment transaction;
predicting, by the one or more processors, an accuracy of the proposed delivery data associated with the fulfillment transaction; and
when the accuracy of the proposed delivery data represents a deviation beyond a threshold, presenting, by the one or more processors, a prompt highlighting the deviation in the proposed delivery data.

2. The method of claim 1, wherein the proposed delivery data is received at a user level, an item level, and a seller level.

3. The method of claim 2, wherein the proposed delivery data at the user level comprises a user identifier and a delivery location.

4. The method of claim 3, wherein the proposed delivery data at the user level further comprises a subscription plan defining shipping terms within the electronic shopping interactive computing environment.

5. The method of claim 4, wherein the proposed delivery data at the seller level comprises a seller identity and a shipment location.

6. The method of claim 5, wherein the proposed delivery data at the seller level further comprises a shipment service delivering the item from the shipment location to the delivery location.

7. The method of claim 6, wherein the proposed delivery data at the item level comprises an item identifier.

8. The method of claim 4, wherein the predicting comprises referencing, by the one or more processors, a past delivery efficiency database storing historical delivery data for the item at the seller level and the user level.

9. The method of claim 1, further comprising proposing, by the one or more processors within the electronic shopping interactive computing environment, alternative items having a lesser deviation in the accuracy of the proposed delivery data.

10. An electronic device, comprising:
a user interface;
a memory; and
one or more processors operable with the user interface and the memory;
wherein the one or more processors, in response to the one or more processors detecting user input selecting an item to be included in a fulfillment transaction within an interactive shopping session in an electronic shopping application operating on the one or more processors, determine a predicted deviation from a promised delivery time for the item and, when the predicted deviation exceeds a threshold, present a prompt on the user interface identifying the predicted deviation from the promised delivery time.

11. The electronic device of claim 10, wherein the one or more processors further propose, on the user interface within the electronic shopping interactive computing environment, alternative items having a lesser predicted deviation than that determined for the item to be included in the fulfillment transaction.

12. The electronic device of claim 11, wherein the one or more processors further identify, on the user interface within the electronic shopping interactive computing environment, the lesser predicted deviation when proposing the alternative items.

13. The electronic device of claim 11, wherein the one or more processors further extract, from the fulfillment transaction, an item identifier, a seller identifier, a shipment location, a delivery location, and a shipment service, wherein the predicted deviation is determined as a function of the item identifier, the seller identifier, the shipment location, the delivery location, and the shipment service.

14. The electronic device of claim 13, wherein the one or more processors are further configured to update a delivery efficiency database with the predicted deviation.

15. The electronic device of claim 10, wherein the prompt comprises a user actuation target configured as a symbol, wherein the predicted deviation from the promised delivery time is initially hidden when the prompt is presented but revealed in response to other user input actuating the user actuation target.

16. A method in an electronic device, the method comprising:
in response to receipt of user input selecting an item to be associated with a fulfillment transaction within an interactive session in an electronic shopping interactive computing environment operating on one or more processors of the electronic device, extracting, by the one or more processors, delivery data at an item level, a user level, and a seller level;
predicting, by the one or more processors, an accuracy of the delivery data associated with the delivery data using prior extracted delivery data for the item at the seller level and user level; and
when the accuracy of the delivery data deviates from a specified delivery time of the delivery data beyond a threshold, presenting, by the one or more processors, a prompt highlighting a predicted deviation from the specified delivery time.

17. The method of claim 16, wherein the prompt includes a user actuation target that, when actuated, causes a user interface to propose alternative items deviating less from the specified delivery time than the predicted deviation.

18. The method of claim 17, further comprising prioritizing the alternative items from lowest deviation from the specified delivery time to highest deviation from the specified delivery time.

19. The method of claim 16, further comprising updating, by the one or more processors, a delivery efficiency database with the predicted deviation from the specified delivery time.

20. The method of claim 16, further comprising presenting, by the one or more processors on a user interface within the electronic shopping interactive computing environment, filter options to exclude other items having a predicted deviation from the specified delivery time.
